(19) United States
(12) Patent Application Publication
(10) Pub. No.: US 2026/0058895 A1
(43) Pub. Date: Feb. 26, 2026

(54) AUTOMATING WHOIS PARSING AND UNDERSTANDING WITH GENERATIVE ARTIFICIAL INTELLIGENCE

(71) Applicant: Palo Alto Networks, Inc., Santa Clara, CA (US)

(72) Inventors: Zhenhua Chen, Milpitas, CA (US); Daiping Liu, Sunnyvale, CA (US); Wanjin Li, Santa Clara, CA (US); Fan Fei, San Jose, CA (US)

(21) Appl. No.: 18/814,216

(22) Filed: Aug. 23, 2024

(51) Int. Cl. H04L 43/18; G06F 40/211; G06F 40/30; H04L 9/40

(52) U.S. Cl. CPC H04L 43/18; G06F 40/211; G06F 40/30; H04L 63/1425

(57) ABSTRACT

Various techniques for automating WHOIS parsing and understanding with generative artificial intelligence are disclosed. In some embodiments, a system, a process, and/or a computer program product for automating WHOIS parsing and understanding with generative artificial intelligence includes receiving a WHOIS record (e.g., the WHOIS record can include unstructured data); processing the WHOIS record at least in part using a generative artificial intelligence (GenAI) model (e.g., including a Large-Language Model (LLM)) to determine a set of predefined data block values applied to meta information for parsing the WHOIS record; and generating an enriched version of the WHOIS record.

### BACKGROUND OF THE INVENTION

Large Language Models (LLMs) are typically trained on publicly available documents. As a result, they may struggle to answer domain-specific questions if such documents were not included in their training data. Retrieval-Augmented Generation (RAG) is an architecture used for knowledge-based question answering, particularly useful when the required data was not part of the model's training set.

RAG can reduce the likelihood of hallucination in LLM responses, though it does not eliminate them entirely. There are several potential failure points in a RAG-based approach that can impact the reliability of the responses. For example, if irrelevant or conflicting documents are retrieved, it may cause the LLM to generate hallucinated responses. Additionally, the absence of relevant documents can also lead to hallucinations in the LLM response.

### BRIEF DESCRIPTION OF THE DRA WINGS

Various embodiments of the invention are disclosed in the following detailed description and the accompanying drawings.

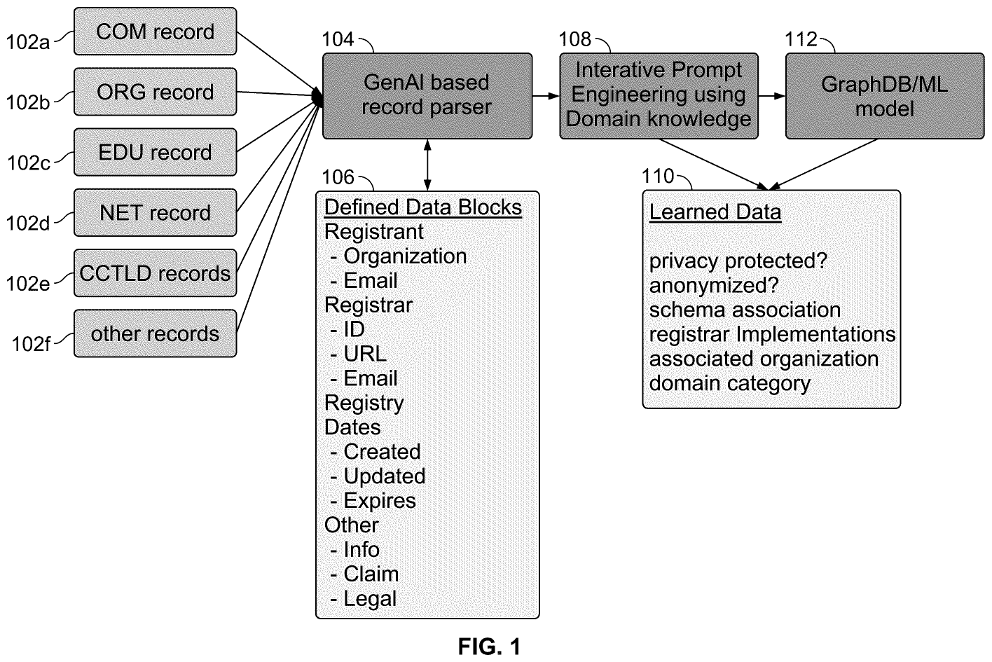

FIG. 1 illustrates an overall system architecture for automating WHOIS parsing and understanding with generative artificial intelligence (GenAI) in accordance with some embodiments.

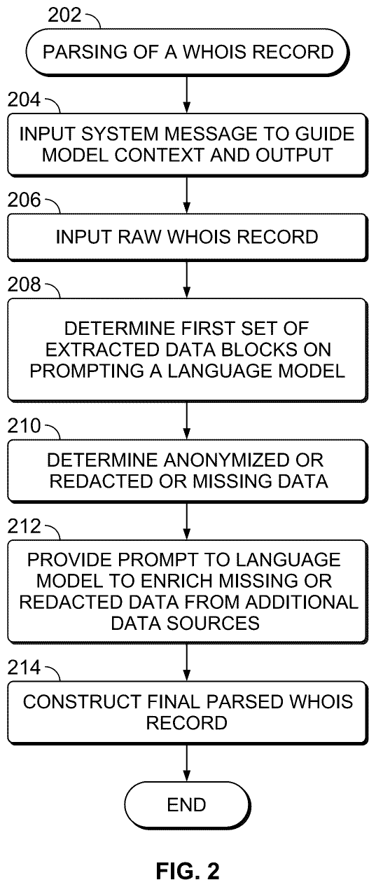

FIG. 2 illustrates a processing flow of operations for a system for automating WHOIS parsing and understanding with generative artificial intelligence (GenAI) in accordance with some embodiments.

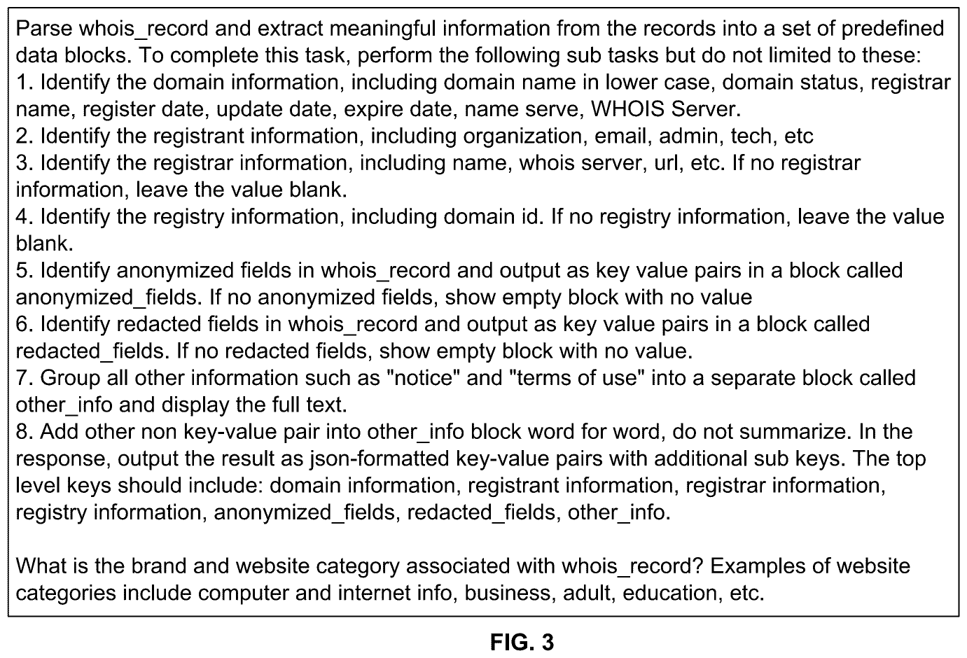

FIG. 3 illustrates example prompts to a language model to enrich missing or redacted data from additional data sources for a system for automating WHOIS parsing and understanding with GenAI in accordance with some embodiments.

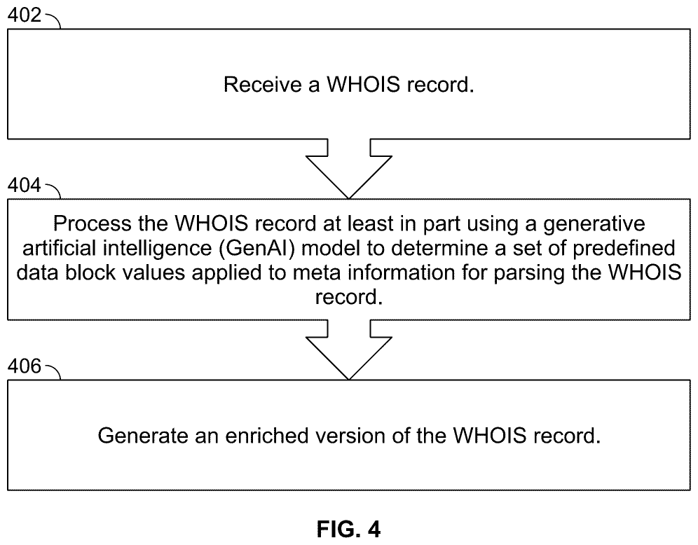

FIG. 4 is a flow diagram for a process for automating WHOIS parsing and understanding with generative artificial intelligence in accordance with some embodiments.

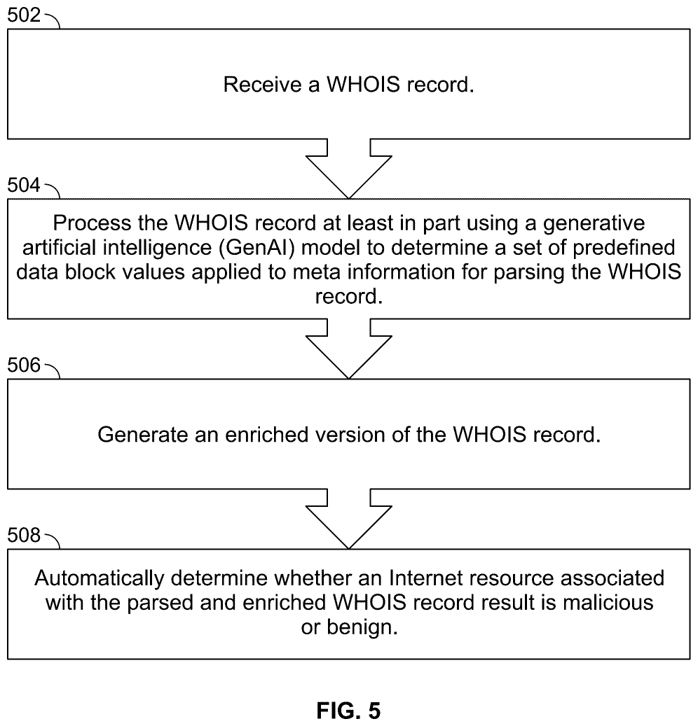

FIG. 5 is another flow diagram for a process for automating WHOIS parsing and understanding with generative artificial intelligence in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Large Language Models (LLMs) are typically trained on publicly available documents. As a result, they may struggle to answer domain-specific questions if such documents were not included in their training data. Retrieval-Augmented Generation (RAG) is an architecture used for knowledge-based question answering, particularly useful when the required data was not part of the model's training set.

RAG can reduce the likelihood of hallucination in LLM responses, though it does not eliminate them entirely. There are several potential failure points in a RAG-based approach that can impact the reliability of the responses. For example, if irrelevant or conflicting documents are retrieved, it may cause the LLM to generate hallucinated responses. Additionally, the absence of relevant documents can also lead to hallucinations in the LLM response.

### Overview of Techniques for Automating WHOIS Parsing and Understanding with Generative Artificial Intelligence (GenAI)

WHOIS generally refers to a query and response protocol that is used for querying databases that store an Internet resource's registered users or assignees. These resources include domain names, IP address blocks, and autonomous systems (e.g., and it is also used for a wider range of other information). The protocol generally stores and delivers database content in a human-readable format. The current iteration of the WHOIS protocol was drafted by the Internet Society as specified in RFC 3912, which is publicly available at https://datatracker.ietf.org/doc/html/rfc3912.

Various enterprise network and security related solutions have use cases for which performing a WHOIS lookup is needed to identify various source information associated with an Internet resource, such as a domain name, Internet Protocol (IP) address (e.g., including IP address blocks and autonomous systems (AS)), etc.

As such, WHOIS is an established and standardized protocol used in the querying of registration information on Internet resources. WHOIS results include human-readable information about the resource, including, for example, owner contact details, creation and expiration dates, and the registrar for which the resource is responsible for.

Due to the growth of the Internet, the management of Internet domains has become distributed and fragmented among several distinct domain name registries and registrars (e.g., WHOIS providers). This has led to inconsistent registration data across different WHOIS providers, which presents technical challenges with automated solutions that attempt to process and parse WHOIS results from such different WHOIS providers.

Further complicating these technical challenges, privacy concerns and data protection laws (e.g., General Data Protection Regulation (GDPR), which is a privacy related regulation implemented in the European Union in 2018 and/or various other national/state related privacy regulations) require certain registration information to be redacted from the record. However, the redaction strategy implementation used by these different WHOIS providers is often inconsistent (i.e., not uniform), which further complicates these technical challenges with automated processing and parsing of such WHOIS results.

However, WHOIS is still a critical resource used in the security community to detect and stop malicious actors and associated malicious campaigns. Existing approaches that typically use either template or rule-based approaches to parse WHOIS records are inaccurate and often ineffective at automated processing and parsing of such WHOIS results (e.g., a minor change in schema or wording can cause such a preconfigured parsing of a WHOIS result to fail).

Thus, new and improved solutions for automatically processing of WHOIS results are needed.

Accordingly, various techniques for automating WHOIS parsing and understanding with generative artificial intelligence are disclosed. As used herein, generative artificial intelligence (AI), also referred to as GenAI, includes AI solutions that can generate new content or data that mimics human-generated content or data. Example GenAI solutions that are commercially or publicly available include ChatGPT from OpenAI, Llama from Meta, Gemini from Google, Claude from Anthropic, and various other GenAI solutions are commercially or publicly available that are capable of generating new content or data that mimic human-generated content or data.

For example, a new WHOIS parser based on GenAI is disclosed that is able to leverage the full power of LLMs trained on vast amounts of knowledge on the Internet. Coupled with domain knowledge, the disclosed GenAI implemented WHOIS parser can perform both syntactic analysis on varying structures of WHOIS records as well as semantic analysis on the chaotic nature of data stored, such as will be further described below.

In some embodiments, a system, a process, and/or a computer program product for automating WHOIS parsing and understanding with generative artificial intelligence (GenAI) includes receiving a WHOIS record (e.g., the WHOIS record can include unstructured data); processing the WHOIS record at least in part using a generative artificial intelligence (GenAI) model (e.g., including a Large-Language Model (LLM)) to determine a set of predefined data block values applied to meta information for parsing the WHOIS record; and generating an enriched version of the WHOIS record.

In an example implementation, iterative prompting of the LLM based on learned domain knowledge can be performed for enriching WHOIS records to perform, for example, one or more of the following: provide syntactic analysis of the WHOIS record; provide semantic analysis of the WHOIS record; identify privacy related redactions in the WHOIS record; and identify one or more fields of the WHOIS record that are inconsistently redacted or anonymized.

In some embodiments, a system, a process, and/or a computer program product for automating WHOIS parsing and understanding with GenAI further includes prompting the GenAI model using iterative prompting to provide enriched WHOIS records.

In some embodiments, a system, a process, and/or a computer program product for automating WHOIS parsing and understanding with GenAI further includes automatically determining whether an Internet resource associated with the parsed and enriched WHOIS record result is malicious or benign.

In some embodiments, a system, a process, and/or a computer program product for automating WHOIS parsing and understanding with GenAI further includes performing prompting of the LLM using tree of thought prompting and/or retrieval augmented generation (RAG) techniques.

In some embodiments, a system, a process, and/or a computer program product for automating WHOIS parsing and understanding with GenAI further includes extending data collection and information enrichment to a plurality of LLMs (e.g., and selecting the most useful results to enrich the WHOIS record(s)).

In some embodiments, a system, a process, and/or a computer program product for automating WHOIS parsing and understanding with GenAI further includes selecting a plurality of features for training the GenAI model (e.g., or graph database techniques can similarly be applied) to automatically classify by syntactic and semantic similarities to identify WHOIS providers' schematic and redaction strategies.

In some embodiments, a system, a process, and/or a computer program product for automating WHOIS parsing and understanding with GenAI further includes enriching the WHOIS record using the LLM, internal data, external Internet search results, and/or other information.

In some embodiments, a system, a process, and/or a computer program product for automating WHOIS parsing and understanding with GenAI further includes cross-validating the LLM generated output with a WHOIS parser (e.g., to mitigate LLM hallucination).

As such, the disclosed techniques for automating WHOIS parsing and understanding with GenAI can effectively and efficiently leverage the power of GenAI and LLMs to efficiently parse and extract data from varying inconsistent record structures and data formats into defined sets of information categories.

In addition, the disclosed techniques for automating WHOIS parsing and understanding with GenAI can effectively and efficiently identify fields that have been inconsistently redacted or anonymized due to varying WHOIS providers' implementations and extract meaningful data that are unredacted.

Further, the disclosed techniques for automating WHOIS parsing and understanding with GenAI can utilize prompt engineering such as Chain-of-Thought (CoT) Prompting, Tree-of-Thought Prompting, Generate Knowledge Prompting, and Retrieval Augmented Generation (RAG) with domain knowledge and search engines results to iteratively further enrich and find missing information.

Moreover, the disclosed techniques for automating WHOIS parsing and understanding with GenAI can extend data collection and information enrichment to multiple GenAI and LLMs and select the most useful results.

Finally, the disclosed techniques for automating WHOIS parsing and understanding with GenAI can be implemented using a machine learning (ML) model that is trained on parsed records to classify by syntactic and semantic similarities to identify WHOIS providers' schematic and redaction strategies.

Additional system embodiments and techniques for automating WHOIS parsing and understanding with GenAI will now be further described below.

### Example System Embodiments for Providing Automating WHOIS Parsing and Understanding with GenAI

The disclosed techniques for automating WHOIS parsing and understanding with generative artificial intelligence solve these technical challenges as will now be further described below.

FIG. 1 illustrates an overall system architecture for automating WHOIS parsing and understanding with generative artificial intelligence (GenAI) in accordance with some embodiments.

In this example implementation, a plurality of records can be provided to a GenAI based record parser 104 for processing, such as a COM record 102a, an ORG record 102b, an EDU record 102c, a NET record 102d, CCTL records 102e, and/or other records 102f.

Referring to GenAI based record parser 104, GenAI can be utilized for the understanding, summary, extraction, and enrichment of data from the raw WHOIS records. As shown, the GenAI based record parser receives and processes various defined data blocks 106. The defined data blocks can include the following: registrant (e.g., including organization and email address); registrar (e.g., including an ID, URL, and email address); registry; dates (e.g., created, updated, expiration); and various other information (e.g., claim, legal, etc.), such as shown.

In this example implementation, the GenAI based record parser performs the following operations as will now be described below: input a System Message to give context and ground the LLM's behavior as a text parser and extractor, provide guidelines on the task breakdown and output format, provide the raw WHOIS record to the LLM as input, and use predefined prompt template(s) to instruct the LLM to parse and extract data into defined sets of data blocks, Domain Info, Registrant Info, Registrar Info, Registry Info, Anonymized Fields, Redacted Fields, and/or various other information. Further, the LLM and search results can be used to enrich and look for missing data (e.g., using a missing fields search, search result summary, etc.).

For example, the disclosed techniques for automating WHOIS parsing and understanding with GenAI can effectively and efficiently identify fields that have been inconsistently redacted or anonymized due to varying providers' implementations and extract meaningful data that are unredacted.

At 108, iterative prompt engineering using domain knowledge is performed. Various examples of such iterative prompt engineering of the LLM will be further described below. For example, various forms of prompt engineering can be performed, such as Chain-of-Thought (CoT) Prompting, Tree-of-Thought Prompting, Generate Knowledge Prompting, and Retrieval Augmented Generation (RAG) with domain knowledge and search engines results to iteratively further enrich and find missing information.

At 110, learned data is determined. Examples of learned data can include one or more of the following related to the WHOIS result(s): privacy protected, anonymized, schema association, registrar implementations, associated organization, domain category, and/or other information can also be learned using the disclosed techniques for automating WHOIS parsing and understanding with GenAI. For example, the ML model can be trained on parsed WHOIS records to classify by syntactic and semantic similarities to identify WHOIS providers' schematic and redaction strategies.

At 112, a graph database/machine learning (ML) model is generated based on the iterative prompt engineering using domain knowledge. In some cases, data collection and information enrichment can be extended to multiple GenAI and LLMs, and the most useful results can then be selected.

As such, the disclosed techniques for automating WHOIS parsing and understanding with GenAI can leverage the power of GenAI and LLMs to efficiently parse and extract data from varying inconsistent record structures and data formats into defined sets of information categories.

For example, the disclosed techniques for automating WHOIS parsing and understanding with GenAI can be applied to overcome syntactic and semantic differences to accurately understand and categorize WHOIS records at scale without the need for pre-engineered rules or templates based on various registrars.

As another example, the disclosed techniques for automating WHOIS parsing and understanding with GenAI can facilitate differentiation and categorization of public versus privacy protected Internet domains.

As yet another example, the disclosed techniques for automating WHOIS parsing and understanding with GenAI can facilitate identification of redacted fields in the WHOIS records.

Finally, the disclosed techniques for automating WHOIS parsing and understanding with GenAI can facilitate enrichment of records to provide more context related to the Internet domain.

FIG. 2 illustrates a processing flow of operations for a system for automating WHOIS parsing and understanding with GenAI in accordance with some embodiments.

At 202, a WHOIS record is received at a system for automated WHOIS parsing and understanding with GenAI, such as similarly described above with respect to FIG. 1.

At 204, a system message is input to guide the GenAI model to guide context and output, such as similarly described above with respect to FIG. 1.

At 206, the raw WHOIS record result is input to the GenAI model, such as similarly described above with respect to FIG. 1.

At 208, a first set of extracted data blocks is determined based on prompting a language model, such as similarly described above with respect to FIG. 1.

At 210, anonymized or redacted or missing data is determined, such as similarly described above with respect to FIG. 1.

At 212, one or more prompts to the language model to enrich missing or redacted data from additional data sources are provided, such as similarly described above with respect to FIG. 1. Example prompts to language models are further described below, such as shown in FIG. 3.

At 214, a final parsed WHOIS record is constructed using the results from the language model, such as similarly described above with respect to FIG. 1.

FIG. 3 illustrates example prompts to a language model to enrich missing or redacted data from additional data sources for a system for automating WHOIS parsing and understanding with GenAI in accordance with some embodiments.

In this example implementation, these prompts illustrate examples of prompt engineering that can be performed to guide a language model, such as ChatGPT from OpenAI or another language model can similarly be used.

Specifically, in this example, prompt templates for WHOIS record parsing and data extraction can include a system message, task list, output format, and data enrichment guidance/instructions, such as shown in FIG. 3.

### Example WHOIS Record Parsing Results

Example WHOIS record parsing results are provided below using various different sources including GenAI based techniques described above, including, in this example, language model query/prompted inference results and Internet search query results as similarly described above with respect to FIGS. 1-3, in this example for the following domain: www.wshifen.com,
Q: summarize
A: The provided record is a WHOIS record for the domain “wshifen.com.” Here are the key details:
Domain Name: wshifen.com
Registry Domain ID: 1736697488_DOMAIN_COM-VRSN
Registrar WHOIS Server: whois.rrpproxy.net
Registrar: Key-Systems GmbH
Creation Date: 2012 Aug. 1T02:37:53Z
Updated Date: 2023 Jun. 30T03:01:24Z
Expiry Date: 2024 Aug. 1T02:37:53Z
Registrar Abuse Contact Email: abuse@key-systems.net
Registrar Abuse Contact Phone: +49.68949396850
Domain Status: ok https://icann.org/epp #ok
Name Servers: NS3. WSHIFEN.COM, NS4.WSHIFEN.COM
DNSSEC: unsigned

The registrant, admin, tech, and billing contact information are redacted for privacy. The registrant country is listed as CN, which stands for China. The domain status “ok” indicates that the domain is not locked or held by the registrar.

The domain is currently set to expire on Aug. 1, 2024. The registrar, Key-Systems GmbH, is a German-based company that provides domain registration and related services. The name servers suggest that the domain is likely to be hosted on its own servers.

As for classification, without more specific details about the content or purpose of the site, it is difficult to categorize it. It could fall under various categories based on its functionality and services it offers.
Q: What is the domain in whois_record?
A: The domain in the provided WHOIS record is “wshifen.com”.
Q: Is whois_record privacy protected?
A: Yes, the WHOIS record provided for the domain “wshifen.com” is privacy protected. This is evident from the repeated use of “REDACTED FOR PRIVACY” in sections pertaining to the Registrant, Admin, Tech, and Billing contact details. This means that the personal contact information of the individual or organization that registered the domain is not publicly available, which is a common measure to protect against spam and potential misuse of personal information.
search_result=“[{‘result_rank’: 1, ‘title’: ‘Hostname: www.wshifen.com-LevelBlue-Open Threat . . . ’, ‘description’: “Learn about the latest cyber threats. Research, collaborate, and share threat intelligence in real time. Protect yourself and the community against today'sÄxa0 . . . ”, ‘url’: ‘https://otx.alienvault.com/indicator/hostname/www.wshifen.com’}, {‘result_rank’: 2, ‘title’: ‘wshifen.com-Domain Info-Baidu’, ‘description’: “Used to identify the user's browsing session. . . . Used to secure both the user and our website against cross-site request forgery attacks. Analytics cookies. WcÄxa0 . . . ”, ‘url’: ‘https://www.netify.ai/resources/domains/wshifen.com’}, {‘result_rank’: 3, ‘title’: ‘wshifen.com whois lookup-who.is’, ‘description’: ‘wshifen.com . . . We will display stored WHOIS data for up to 30 days. . . . Use promo code WHOIS to save 15% on your first Name.com order. . . . Use promo code WHOIS toAxaO . . . ’, ‘url’: ‘https://who.is/whois/wshifen.com’}, {‘result_rank’: 4, ‘title’: ‘Nanoleaf calling out to unknown website’, ‘description’: ‘I have noticed my nanoleafs are calling out to a website based in China about 4000 times a day on both IPv6 and ipv4. wshifen.com.’, ‘url’: ‘https://www.reddit.com/r/Nanoleaf/comments/10vtm32/nanoleaf_calling_out_to_unknown_web site/’}, {‘result_rank’: 5, ‘title’: ‘Domain: www.wshifen.com’, ‘description’: ‘Domain: www.wshifen.com. Reports, passive DNS (pDNS) records, subdomains, Uniform Resource Locators (URLs) and malware samples associated with www.wshifen.com.’, ‘url’: ‘https://www.threatminer.org/domain.php?q=www.wshifen.com’}, {‘result_rank’: 6, ‘title’: ‘Malware analysis www.wshifen.com Malicious activity’, ‘description’: ‘Mar. 4, 2024-Online sandbox report for www.wshifen.com, verdict: Malicious activity.’, ‘url’: ‘https://any.run/report/7167af491d9d286205d822ca51bff36c7f691a7f99165689c3907688dbe98 7a5/751bb7fc-3ad2-41d0-bd46-2e5bc3601c35’}, {‘result_rank’: 7, ‘title’: ‘DNS records for wshifen.com’, ‘description’: ‘With DNS lookup, you can find the DNS record for any domain name or subdomain. When you enter the domain, it will show all the DNS records that are configuredÄxa0 . . . ’, ‘url’: ‘https://www.nslookup.io/domains/wshifen.com/dns-records/’}]”
Q: what information can you find on www.wshifen.com from search_result?
A: Based on the provided search results, the following information can be gleaned about the domain “www.wshifen.com”:
Cyber Threats: The domain has been discussed in the context of cyber threats on the Alien Vault platform, suggesting potential security concerns related to the domain.
User Browsing Sessions and Security: The domain is discussed in terms of user browsing sessions and cross-site request forgery attacks on Netify's website, indicating it might have a role in these activities.
Connection with Nanoleaf Device: A Reddit user has noticed their Nanoleaf device (smart lighting product) frequently accessing ‘wshifen.com’. This could suggest that the domain is in some way linked to Nanoleaf's services, or it might indicate suspicious activity.
Malicious Activity: The domain has been associated with malicious activity according to a report on any.run.
DNS Records: NSLookup provides DNS record information for the domain, which could be useful for technical investigation.
Additional Data: ThreatMiner associates the domain with various reports, passive DNS (pDNS) records, subdomains, Uniform Resource Locators (URLs), and possibly malware samples.
Q: Explain how www.wshifen.com is used and by what organization from search_result, think step by step for record in search_result provided, extract any popular organizations.
A: I apologize for any confusion earlier. After reviewing the search results you've provided, it appears that the domain www.wshifen.com may have some association with Baidu, a large Chinese technology company specializing in Internet-related services and products.
Alien Vault (OTX): This platform has listed the domain www.wshifen.com, indicating that it may be associated with certain cyber threats. However, there's no specific organization mentioned in relation to this domain.
Netify.ai: The description indicates that www.wshifen.com is used to identify user's browsing sessions and secure them against cross-site request forgery attacks. The page also uses analytics cookies. However, the organization behind it isn't clearly identified.
WHOIS: The domain's information can be obtained from the WHOIS lookup service. However, the specific details from the WHOIS record aren't provided in your search results.
Reddit (Nanoleaf): A Reddit user has noticed their Nanoleaf device frequently accessing ‘wshifen.com’. Although this might suggest that Nanoleaf has some interaction with this domain, it doesn't necessarily mean Nanoleaf owns or operates it.
ThreatMiner: This domain appears in ThreatMiner, which suggests it has been associated with certain threats or malicious activities. Again, no specific organization is linked to the domain in this result.
Any.run: This cybersecurity service indicates that ‘wshifen.com’ has been associated with malicious activities. However, there is no mention of any organization related to this domain.
NSlookup.io: This tool provides DNS records for the domain, possibly offering insight into its configuration and usage. But the specific details from the DNS records aren't provided in your search results.

The only specific organization mentioned in the search results is Baidu, in the title of the second search result (“wshifen.com-Domain Info-Baidu”). This could suggest that Baidu has some affiliation with the domain, but it's not explicitly confirmed in the search results. A more detailed analysis of the WHOIS record, DNS records, or direct confirmation from Baidu would be needed to verify this.

### Google Gemini Result

##wshifen.com Investigation

Let's dig into what we can find about wshifen.com! Here's what I've discovered so far:
**Suspicious Activity:** Analysis reports from services like ANY.RUN suggest potential malicious activity linked to the domain ([source] (not available due to potential malware)).
**Limited Information:** There's no clear consensus on the domain's purpose. Baidu, a Chinese search engine, lists it as “associated with the Baidu application,” but this information might be inaccurate ([source] (not available due to potential privacy concerns)).
**Nanoleaf Connection:** There are user reports of Nanoleaf devices, known for customizable LED lighting panels, contacting wshifen.com frequently. This suggests the domain might be involved in data collection for the Nanoleaf product, but official confirmation is needed ([source] (reddit.com)).
**Classification:** Based on the available information, it's difficult to definitively classify wshifen.com. The suspicious activity reports and lack of clear purpose raise red flags.
**Here's what we can do next:**
**Search for news articles or security reports** mentioning wshifen.com.
**Try contacting Nanoleaf support** to understand why their devices connect to this domain.
**Avoid visiting the website** unless you have a strong reason and take appropriate security precautions.

Remember, exercising caution is key. It's best to avoid this domain until there's more clarity about its purpose and safety.
Q: What organizations are related to wshifen.com?
A: Based on the information I gathered earlier, here are some potential organizations related to wshifen.com:
Nanoleaf: User reports suggest Nanoleaf devices connect to wshifen.com, possibly for data collection purposes. However, there's no official confirmation from Nanoleaf itself. Searching for official statements from Nanoleaf about their connection to wshifen.com might be helpful.
Domain Registrar: Looking up the domain registrar for wshifen.com could reveal some information about the domain owner or who registered it. This might provide clues about the organization behind it. However, keep in mind that some domain owners use privacy protection services to hide their identity.
Security Firms: Running wshifen.com through security analysis tools offered by some security firms might provide insights into the organizations or IP addresses associated with the domain. Some security firms offer free basic checks, while others might require a paid subscription.

### Example Use Cases for Automating WHOIS Parsing and Understanding with GenAI

As a first example use case, the disclosed techniques for automating WHOIS parsing and understanding with GenAI can be applied to provide a general WHOIS parser that is not template dependent or rule dependent.

As a second example use case, the disclosed techniques for automating WHOIS parsing and understanding with GenAI can be applied to provide a database of rich WHOIS records parsed and further enriched by GenAI models using prompt engineering and Internet search results.

As a third example use case, the disclosed techniques for automating WHOIS parsing and understanding with GenAI can be applied to identify falsely identified malicious domains from security products that belong to legitimate organizations.

As a fourth example use case, the disclosed techniques for automating WHOIS parsing and understanding with GenAI can be applied to identify true malicious/suspicious domains that belong to malicious actors.

Additional process embodiments and techniques for automating WHOIS parsing and understanding with generative artificial intelligence will now be further described below.

### Example Process Embodiments for Providing Automating WHOIS Parsing and Understanding with GenAI

FIG. 4 is a flow diagram for a process for automating WHOIS parsing and understanding with generative artificial intelligence in accordance with some embodiments. In some embodiments, a process as shown in FIG. 4 is performed by the system/service and techniques as similarly described above including the embodiments described above with respect to FIGS. 1-3.

At 402, a WHOIS record is received. For example, the WHOIS record includes unstructured data.

At 404, processing the WHOIS record at least in part using a generative artificial intelligence (GenAI) model is performed to determine a set of predefined data block values applied to meta information for parsing the WHOIS record.

In an example implementation, iterative prompting of the LLM based on learned domain knowledge can be performed for enriching WHOIS records to perform, for example, one or more of the following: provide syntactic analysis of the WHOIS record; provide semantic analysis of the WHOIS record; identify privacy related redactions in the WHOIS record; and identify one or more fields of the WHOIS record that are inconsistently redacted or anonymized.

At 406, an enriched version of the WHOIS record is automatically generated.

FIG. 5 is another flow diagram for a process for automating WHOIS parsing and understanding with generative artificial intelligence in accordance with some embodiments. In some embodiments, a process as shown in FIG. 5 is performed by the system/service and techniques as similarly described above including the embodiments described above with respect to FIGS. 1-3.

At 502, a WHOIS record is received. For example, the WHOIS record includes unstructured data.

At 504, processing the WHOIS record at least in part using a generative artificial intelligence (GenAI) model is performed to determine a set of predefined data block values applied to meta information for parsing the WHOIS record.

In an example implementation, iterative prompting of the LLM based on learned domain knowledge can be performed for enriching WHOIS records to perform, for example, one or more of the following: provide syntactic analysis of the WHOIS record; provide semantic analysis of the WHOIS record; identify privacy related redactions in the WHOIS record; and identify one or more fields of the WHOIS record that are inconsistently redacted or anonymized.

At 506, an enriched version of the WHOIS record is automatically generated.

At 508, whether an Internet resource associated with the parsed and enriched WHOIS record result is malicious or benign is automatically determined. For example, an action can be performed if the WHOIS record is determined to be malicious (e.g., adding the domain/Internet resource associated with the WHOIS record to a block list and/or other actions can be similarly performed).

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
receive a WHOIS record;
process the WHOIS record at least in part using a generative artificial intelligence (GenAI) model to determine a set of predefined data block values applied to meta information for parsing the WHOIS record; and
generate an enriched version of the WHOIS record; and
a memory coupled to the processor and configured to provide the processor with instructions.

2. The system of claim 1, wherein the WHOIS record includes unstructured data.

3. The system of claim 1, wherein the GenAI model includes a Large-Language Model (LLM).

4. The system of claim 1, wherein the GenAI model includes a Large-Language Model (LLM), and wherein iterative prompting of the LLM based on learned domain knowledge is performed for enriching WHOIS records.

5. The system of claim 1, wherein the GenAI model provides syntactic analysis of the WHOIS record.

6. The system of claim 1, wherein the GenAI model provides semantic analysis of the WHOIS record.

7. The system of claim 1, wherein the GenAI model identifies privacy related redactions in the WHOIS record.

8. The system of claim 1, wherein the GenAI model identifies one or more fields of the WHOIS record that are inconsistently redacted or anonymized.

9. The system of claim 1, wherein the processor is further configured to:
prompt the GenAI model using iterative prompting to provide enriched WHOIS records.

10. The system of claim 1, wherein the processor is further configured to:
automatically determine whether an Internet resource associated with a parsed and enriched WHOIS record result is malicious or benign.

11. A method, comprising:
receiving a WHOIS record;
processing the WHOIS record at least in part using a generative artificial intelligence (GenAI) model to determine a set of predefined data block values applied to meta information for parsing the WHOIS record; and
generating an enriched version of the WHOIS record.

12. The method of claim 11, wherein the WHOIS record includes unstructured data.

13. The method of claim 11, wherein the GenAI model includes a Large-Language Model (LLM).

14. The method of claim 11, wherein the GenAI model includes a Large-Language Model (LLM), and wherein iterative prompting of the LLM based on learned domain knowledge is performed for enriching WHOIS records.

15. The method of claim 11, wherein the GenAI model provides syntactic analysis of the WHOIS record.

16. The method of claim 11, wherein the GenAI model provides semantic analysis of the WHOIS record.

17. The method of claim 11, wherein the GenAI model identifies privacy related redactions in the WHOIS record.

18. The method of claim 11, wherein the GenAI model identifies one or more fields of the WHOIS record that are inconsistently redacted or anonymized.

19. A computer program product embodied in a non-transitory computer readable medium and comprising computer instructions for:
receiving a WHOIS record;
processing the WHOIS record at least in part using a generative artificial intelligence (GenAI) model to determine a set of predefined data block values applied to meta information for parsing the WHOIS record; and
generating an enriched version of the WHOIS record.

20. The computer program product of claim 19, wherein the GenAI model includes a Large-Language Model (LLM).
